(19) United States
(12) Patent Application Publication
(10) Pub. No.: US 2003/0036427 A1
(43) Pub. Date: Feb. 20, 2003

(54) COIN COUNTER AND TICKET DISPENSER FOR A GAME MACHINE

(76) Inventors: Steve Brandstetter, Merrick, NY (US); James Devlin, East Meadown, NY (US)

Correspondence Address: WEISS & WEISS, SUITE 305, 500 OLD COUNTRY ROAD, GARDEN CITY, NY, 11530, US

(21) Appl. No.: 09/933,067

(22) Filed: Aug. 20, 2001

(51) Int. Cl. A63F 13/00

(52) U.S. Cl. 463/29; 463/25; 463/42

(57) ABSTRACT

A gaming system which pays out a bonus to a player playing a gaming machine.

### FIELD OF THE INVENTION

A gaming system which pays out a bonus to a player playing a gaming machine.

### BACKGROUND OF THE INVENTION

U.S. Pat. No. 5,810,664 relates to an electronic gaming apparatus which preferably corresponds to and effectively automates games of chance, for example, the game known as the “pull-tab”. The apparatus is generally played by a single player and is designed to dispense a ticket containing indicia thereon. A large number of tickets are in the apparatus and the player actuates the apparatus and obtains a dispensed ticket. If the indicia which appears on the ticket constitutes winning or scoring indicia, the player obtains a reward. All tickets are preprinted and may be dispensed from a bin containing pre-cut tickets. Otherwise, the tickets may be severed from a strip in the form of a roll containing all of the tickets sequentially. The apparatus comprises a display means which displays each of the indicia on a ticket. The display is operated in a manner so that the indicia are effectively scrolled across the display screen to generate an image of rotating wheels which display the indicia. A method of distributing pre-printed rolls of tickets is provided such that each player of the gaming apparatus plays against every other player and not just the gaming apparatus.

U.S. Pat. No. 4,652,998 relates to a video gaming system with pool prize structures including remote game terminals and a central controller with two-way communications between the remote game terminals and the central controller. Prize awards are based upon random shuffling of a set of prize awards among a predetermined pool of plays for each remote game terminal. This ensures an equal distribution of prize awards to each remote game terminal. The shuffling of prizes is based on a random seed produced by the remote terminal of the central controller or both.

U.S. Pat. No. 6,224,484 relates to a progressive gaming system comprising a plurality of gaming machines, each of which is constructed to perform a predetermined main game in response to an operation of a player and gives a prize to the player when a winning combination is formed in the main game; and a progressive unit for counting an amount of a progressive bonus based on an amount of a bet in the main game played in each of the gaming machines and controlling a payment of the progressive bonus in association with a result of the main game. Each of the gaming machines or the progressive unit is provided with a judging device for judging whether or not the result of the main game played in each of the gaming machines meets a predetermined bonus chance condition for proceeding to a lottery game. The progressive unit comprises a controller for performing the lottery game in response to a judgment that the result of the main game meets the bonus chance condition, instructing one of the gaming machines, in which the result of the main game meets the bonus chance condition, to pay the progressive bonus corresponding to a result of a lottery game, and displaying information regarding a process of the lottery game.

U.S. Pat. No. 6,244,595 relates to a progressive bonus ticket redemption arcade game. An arcade game including a progressive bonus apparatus is connected to a plurality of individual game units. The progressive bonus apparatus receives score contributions from each game unit to increase a progressive score. When players achieve a predetermined task on a game unit, they receive a non-monetary award based on the progressive score. Each game unit connected to the progressive bonus apparatus may take the form of an arcade-type game with a rotating wheel on which to base scoring. A playing piece is directed down a playing surface towards a target end, and the wheel is rotated according to the target that was hit by the playing piece. The position of the wheel when it stops rotating affects the score. A non-monetary award based on the score is dispensed to the player when the game is completed.

U.S. Pat. No. 6,015,344 relates to a prize redemption system for use with one or more game apparatuses. A game is provided on a game apparatus for a player to play in exchange for monetary input, and prize credits are credited to the player based on the game. A prize selection menu is displayed by the game apparatus, the menu including one or more prizes, where the player may select a prize having a prize cost within the player's prize credit amount. The player can be dispensed a specific prize ticket from the game apparatus or other unit that is redeemable for the selected prize. The game apparatus can also provide specific prizes and tournament games played for a tournament prize. An operator can adjust prizes and payout percentages of the system to achieve a desired profitability for game apparatuses. Prize input is entered into a prize table describing multiple available prizes and payout information that indicates a desired amount of payout that the operator wishes to provide back to players. Prize information, such as prize costs and specific prize win ratios is automatically determined by the system for each of the prizes in view of the desired profitability of the game apparatus.

U.S. Pat. No. 5,941,771 relates to a gaming machine which prints and dispenses game tickets. Ticket substrates are imprinted with game indicia in accordance with game sequence information stored in an electronic memory module. The ticket substrates may be intrinsically valuable articles such as telephone calling cards. The gaming machine of the invention comprises a payment acceptance device for receiving payment, a supply of ticket substrates installed in a gaming machine, and a ticket dispenser for dispensing game tickets one at a time from the supply of tickets. The gaming machine further comprises an electronic memory module which stores game sequence information. As a game ticket is dispensed, a printer in the gaming machine prints game inidicia on the ticket substrate in accordance with the game sequence information retrieved from the electronic memory module.

U.S. Pat. No. 6,193,608 relates to a method for motivating players to return to a casino using premiums, which includes receiving a predetermined value of casino currency to cash. Upon a receipt of the request, a premium value is calculated based at least in part on the predetermined value. Subsequently, the customer is provided an instrument having a total value equal to the predetermined value plus the premium value when the instrument is used at the casino. The instrument may comprise a check having a negotiable value equal to the predetermined value, and a second pay-line defining the total value with the premium to be provided if the check is cashed at the issuing casino.

U.S. Pat. No. 6,251,014 relates to a gaming machine having a plurality of gaming peripherals each communicating with a master gaming controller via a standard peripheral interface such as the Universal Serial Bus. Further, the gaming peripherals employ a standard peripheral controller and one or more specialized “peripheral devices”, e.g., the actual lights, bill validators, ticket printers, etc., that perform the specific functions of the gaming peripherals. Much of the hardware associated with the peripheral controller is identical from one gaming peripheral to the next. Only a portion of the peripheral controller hardware is specific to the different types of gaming peripherals.

U.S. Pat. No. 6,113,098 relates to gaming devices which dispense tickets which are supplemental to the gaming award. The gaming devices provide gaming awards, typically in the form selected from the group consisting of coins, currency, credits or redeemable tickets in response to a randomly determined event, and also provide supplemental tickets. The term tickets is used to indicate an item which may not have any inherent value such as an advertisement or announcement, however, it may be redeemable for services, currency, discounts, or other goods of value. Gaming devices are provided which randomly determine and then provide a gaming award, and also comprise means for dispensing tickets independently of a random event determining device. The supplemental ticket dispenser can dispense supplemental tickets in response to signals generated by the gaming establishment in response to a signal input at a remote location. The supplemental ticket dispenser can also dispense supplemental tickets randomly throughout the day requiring that the game be played or not be played. Tickets can be dispensed depending on the outcome of another gaming device. For example, if one gaming device provides a substantial prize, surrounding gaming devices can be provided with a consolation supplemental ticket. In another example, supplemental tickets are dispensed if the gaming device containing the supplemental ticket dispenser is being played at a certain minimum rate of play, e.g., four plays per minute. Thus, the rate of play can be a threshold above which the player must play to qualify for a supplemental ticket, while the actual dispensing of the supplemental ticket will depend on another criteria, such as a timer, a random number generator, etc.

### SUMMARY OF THE INVENTION

The present invention relates to a gaming system which pays out a bonus to a player playing a gaming machine, the bonus being supplemental to the gaming award. The bonus can be a sweepstakes, lottery or raffle style ticket. The bonus can be redeemable for services, currency, discounts or other goods of value. The gaming system comprises at least one gaming machine and dispenser unit. The dispensing unit delivers a slip of paper that is generated by the gaming system after a player has deposited a set number of coins.

It is an object of the present invention to place a numeric counter on the dispensing unit that alerts a player as to the set number of coins which has been placed into the machine and when the next sweepstakes, lottery or raffle ticket will be generated. It is an object of the present invention to reset the numeric counter once a bonus is generated. At certain times a drawing is held to determine a winner of the raffle sweepstakes or lottery ticket. The bonus prize can be generated from a percentage of the total coins placed into all the participating gaming machines.

The present invention is a progressive gaming platform that dispenses a tangible lottery or sweepstakes ticket. It is an object of the present invention to provide the ticket via a side-mounted box that is attached to a traditional slot machine cabinet. It is an object of the present invention to provide the ticket via a box placed inside the gaming machine. It is an object of the present invention to provide a secondary progressive jackpot ticket dispensed from a side mounted or internal box, once a fixed dollar or coin-in limit has been reached. It is an object of the present invention for the progressive jackpot to be deducted or tabulated as a fixed percentage or hold from the total dollars wagered specifically on machines that contain the dispensers. It is an object of the present invention to show a user the coins that have been added to the machine and the number of coins needed to add to the machine before a bonus is distributed to the user.

It is an object of the present invention for the box to be an add-on to any existing slot machines and gaming devices including video poker machines, video bingo games and video keno games.

It is an object of the present invention for the box to be a self contained unit that does not affect the play or outcome of the slot machine or gaming device.

It is an object of the present invention for the unit to count coin pulses off of the slot machines hard meter, and bonuses a player based on the number of coins or pulses played.

It is an object of the present invention for the unit to count up or down. It is an object of the present invention for the unit to count various coin denominations, e.g., nickel, dime, quarter or dollar slots.

It is an object of the present invention to provide a counter which visually or by audio alerts the player as to how many coins have been played at a particular machine. The system does not count unplayed credits or dollar bills put into the bill validator, and allows the player to know when the next bonusing event will occur.

Tickets dispensed by the system of the present invention can take a number of forms. It is an object of the present invention for the ticket to be a raffle ticket where the player signs their name and address on it and drops it in a bin for a daily or weekly drawing at the casino. It is an object of the present invention for the ticket to be a sweepstakes ticket where many numbers are drawn and multiple types of prizes are given. The system of the present invention can also be progressively linked to offer large jackpots that can include other casino establishments. The ticket dispensed can be a debit card for use at the casino, i.e., restaurants or gift shops. It is an object of the present invention for the ticket to offer marketing on the back of it. This marketing can direct a player to other events at a casino or a web site.

It is an object of the present invention for the ticket to take the form of a Bingo ticket, Keno ticket or Sweepstakes/Lottery ticket. The drawing can be a raffle type ticket where the ticket is picked from a barrel. The drawing can be in the form of a bingo game, keno game, or in the same style as a lottery drawing.

It is an object of the present invention for the ticket to be pre-printed and have the drawing numbers on it when dispensed. It is an object of the present invention for the tickets to be printed by the unit using a random number generator, and lottery style software system.

It is an object of the present invention for the ticket to take the form of a poker card, entry into a horse racing event, or for play on sporting events.

It is an object of the present invention to link multiple units so that a combination of units has to have a certain number of coins inserted before a ticket is dispensed.

### BRIEF DESCRIPTION OF THE DRAWINGS

FIG. 1 is an embodiment illustrating a dispensing unit of the present invention attached to a gaming machine.

FIG. 2 is an embodiment illustrating a dispensing unit of the present invention.

FIG. 3 is an embodiment illustrating internally a gaming machine and a dispensing unit of the present invention.

### DETAILED DESCRIPTION OF THE INVENTION

The present invention relates to a gaming system which pays out a bonus to a player playing a gaming machine, the bonus being supplemental to the gaming award. The bonus can be a sweepstakes, lottery or raffle style ticket. In an embodiment, the dispensing unit delivers a slip of paper that is generated by the gaming system after a player has deposited a set number of coins.

In a preferred embodiment, the unit comprises a numeric counter that alerts the player as to the set number of coins placed into a gaming machine and how many more coins have to be inserted into the gaming machine before the next sweepstakes, lottery or raffle ticket will be generated. The number of coins shown on the numeric counter will continue from player to player until the system distributes a ticket. The system then resets the counter to zero. In an embodiment, the coin counter can reset to zero after a certain amount of time has lapsed between the introduction of coins to the gaming machine. In an embodiment, the amount of coins necessary to receive a ticket can be changed by a remote unit. For example, one unit can say a player needs $20.00 worth of coins to receive a ticket. A few minutes later, from a wireless control, the unit can have an amount of $15.00 worth of coins to receive a ticket.

In one embodiment, at certain times a drawing is held to determine a winner. In an embodiment, the bonus prize can be generated from a percentage of the total coins placed into all the participating gaming machines.

The present invention is a progressive gaming platform that dispenses a tangible lottery or sweepstakes ticket. In one embodiment, the present invention provides the ticket via a side-mounted box that is attached to a traditional slot machine cabinet. In another embodiment, the present invention provides the ticket via a box placed inside the gaming machine. In an embodiment, the present invention provides a secondary progressive jackpot ticket dispensed from a side mounted or internal box, once a fixed dollar or coin-in limit has been reached. In an embodiment, the progressive jackpot is deducted or tabulated as a fixed percentage or hold from the total dollars wagered specifically on machines that contain the dispensers. The present invention shows the coins that have been added to the machine and the number of coins needed to add to the machine before a bonus is distributed to the user.

The unit can show the number of coins necessary to receive a ticket either visually, or through an audio system that tells the user how many coins are needed to receive a ticket.

It an embodiment of the present invention the box can be an add-on to any existing slot machines and gaming devices including video poker machines, video bingo games and video keno games.

In an embodiment of the present invention the box is a self contained unit that does not affect the play or outcome of the slot machine or gaming device.

In an embodiment of the present invention the unit counts coin pulses off of the slot machines hard meter, and bonuses a player based on the number of coins or pulses played.

In an embodiment of the present invention the unit counts up or down. The unit counts various coin denominations, e.g., nickel, dime, quarter or dollar slots.

In an embodiment the present invention provides a counter which visually or by audio alerts the player as to how many coins have been played at a particular machine. The system does not count unplayed credits or dollar bills put into the bill validator, and allows the player to know when the next bonusing event will occur.

Tickets dispensed by the system of the present invention can take a number of forms. In an embodiment of the present invention the ticket is a raffle ticket where the player signs their name and address on it and drops it in a bin for a daily or weekly drawing at the casino. In an embodiment of the present invention the ticket is a sweepstakes ticket where many numbers are drawn and multiple types of prizes are given. In an embodiment of the present invention, the lottery drawing is done on a web site, where the holder of the lottery ticket can also purchase discounted goods on the web site by using the lottery ticket.

The system of the present invention can also be progressively linked to offer large jackpots that can include other casino establishments. In an embodiment, the ticket dispensed is a debit card for use at the casino, i.e., restaurants or gift shops. The ticket can offer marketing on the back of it. This marketing can direct a player to other events at a casino or a web site.

In an embodiment of the present invention the ticket takes the form of a Bingo ticket, Keno ticket or Sweepstakes/Lottery ticket. The drawing can be a raffle type ticket where the ticket is picked from a barrel. The drawing can be in the form of a bingo game, keno game, or in the same style as a lottery drawing.

In an embodiment of the present invention the ticket is pre-printed and has the drawing numbers on it when dispensed. In an embodiment of the present invention the tickets to be printed by the unit use a random number generator, and lottery style software system.

In an embodiment of the present invention the ticket takes the form of a poker card, entry into a horse racing event, or for play on sporting events.

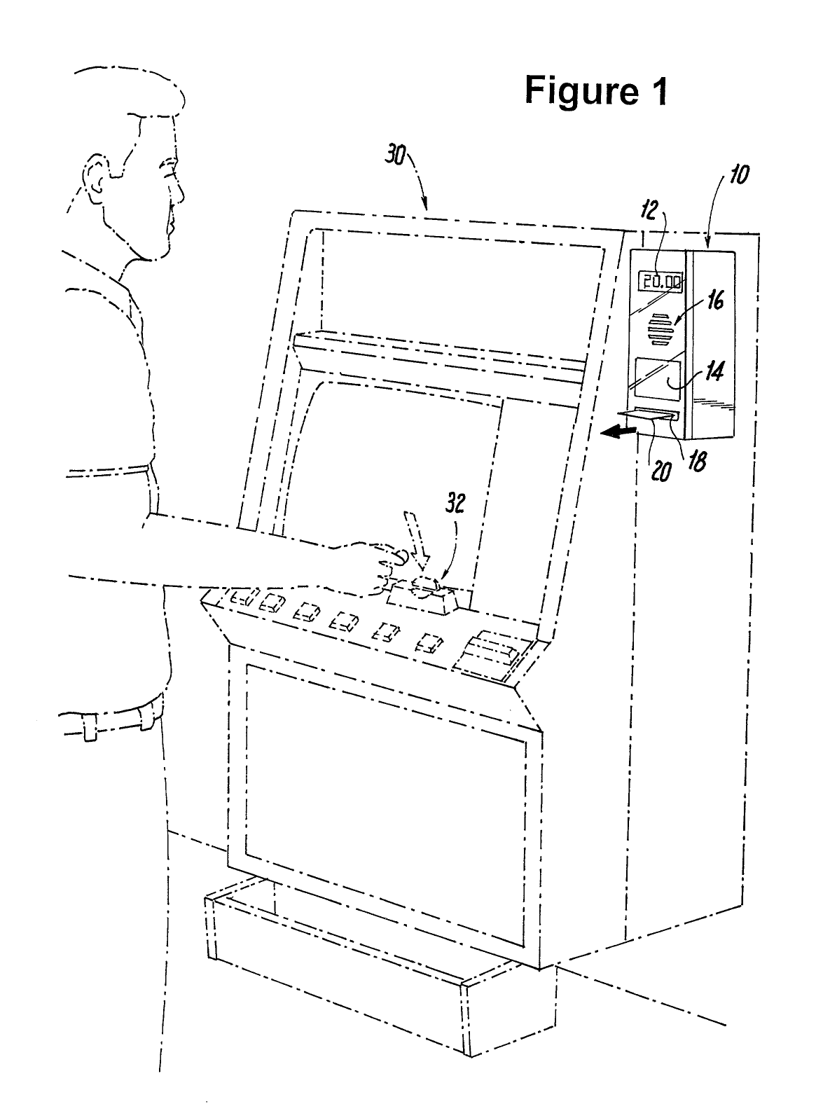

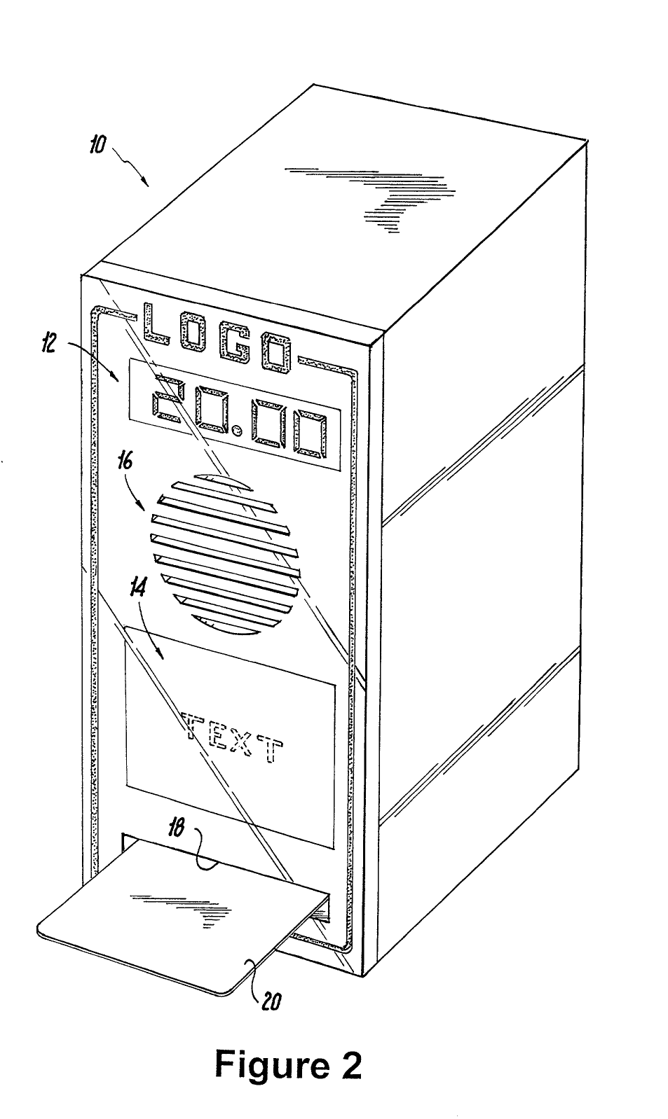

FIG. 1 is an embodiment illustrating a dispensing unit 10 of the present invention attached to a gaming machine 30. FIG. 2 is an embodiment illustrating the dispensing unit 10 of the present invention. Dispensing unit 10 has a numeric counter 12 which shows how many coins or how much money has been placed into the gaming machine 30 through, for example, a coin slot 32. The user is told either by audio, such as with a speaker 16, or visually such as by an LCD display 14 how many coins or how much money is needed before a ticket 20 is provided by a dispensing mechanism 18.

In a further embodiment, the dispensing unit 10 can be placed inside gaming machine 30.

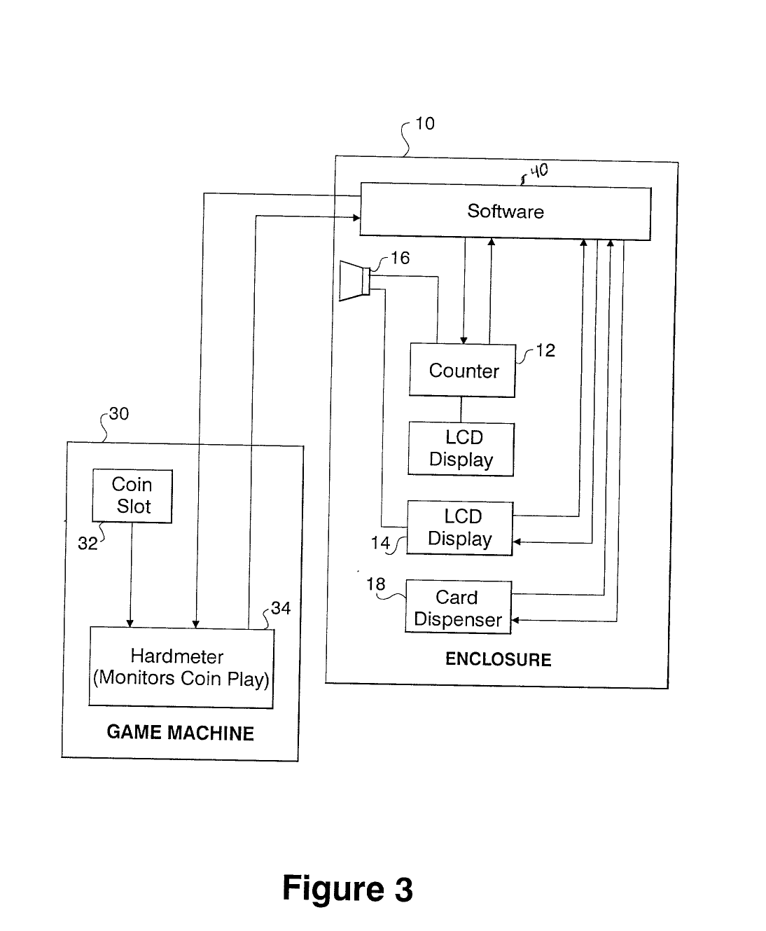

FIG. 3 illustrates internally a gaming machine and a dispensing unit of the present invention. A user places a coin into a coin slot 32 of a gaming machine 30. The Hardmeter 34 monitors the coins played in gaming machine 30. The Hardmeter 34 is connected to software 40 contained in the dispensing unit 10. When the software 40 reads that a coin has been deposited in the gaming machine 30, by a pulse of the hardmeter 34, it instructs the counter 12 to either visually display the number of coins that have been deposited in the gaming machine 30 or through a speaker 16 tells a user how many coins have been placed into the gaming machine 30. The software 40 instructs the unit 10 to either visually through LCD display 14 or through speaker 16 tell the user how many more coins have to be deposited into the gaming machine 30 before a ticket is dispensed through card dispenser 18. Once a ticket has been dispensed through card dispenser 18, the software instructs the numeric counter 12 to reset to zero.

What is claimed is:

1. A device for paying out a bonus to a player playing a gaming machine comprising;
a gaming machine;
a dispensing unit comprising a numeric counter for counting the number of coins a player has placed in said gaming machine;
said dispensing unit further comprising a means for showing a player when a ticket will be generated; and
said dispensing unit further comprising a ticket dispensing apparatus.

2. The device of claim 1 wherein said dispensing unit is a side-mounted box attached to said gaming machine.

3. The device of claim 1 wherein said dispensing unit is placed inside said gaming machine.

4. The device of claim 1 wherein said dispensing unit is an add-on to any existing gaming machine and gaming device.

5. The device of claim 1 wherein said gaming machine includes video poker machines, video bingo games and video keno games

6. The device of claim 1 wherein said dispensing unit is a self contained unit that does not affect play or outcome of said gaming machine.

7. The device of claim 1 wherein said numeric counter counts coin pulses off of said gaming machine's hard meter, and bonuses a player based on number of coins or pulses played.

8. The device of claim 1 wherein said numeric counter can count various coin denominations, e.g., nickel, dime, quarter or dollar slots.

9. The device of claim 1 wherein said ticket is a raffle, sweepstakes or lottery ticket.

10. The device of claim 1 wherein said dispensing units are linked so that a combination of devices has to have a certain number of coins inserted before a ticket is dispensed.

11. The device of claim 1 further comprising;
a remote unit for changing the number of coins necessary to generate said ticket.

12. A process for paying out a bonus to a player playing a gaming machine comprising;
placing coins in a gaming machine;
counting said coins players place in said gaming machine;
showing said number of counted coins to said player;
showing said player number of coins needed for a ticket to be generated;. and
dispensing a ticket when said number of counted coins equals said number of coins needed for a ticket to be generated.

13. The process of claim 12 wherein said counting of said coins is accomplished by counting coin pulses off of said gaming machine's hard meter, and dispensing a ticket based on number of coins or pulses played.

14. The process of claim 12 wherein said ticket is a raffle, sweepstakes or lottery ticket.

15. The process of claim 14 further comprising;
holding a drawing to determine a winner of said ticket

16. The process of claim 12 further comprising:
generating a bonus prize from a percentage of total coins placed into all participating gaming machines.

17. The process of claim 12 further comprising:
resetting said counted coins to zero once a ticket is dispensed.

18. The process of claim 12 further comprising;
changing said number of coins needed to generate said ticket from a remote unit.
